(19) United States
(12) Patent Application Publication
(10) Pub. No.: US 2026/0050788 A1
(43) Pub. Date: Feb. 19, 2026

(54) REDUCING DIMENSIONALITY OF MULTIMODAL EMBEDDINGS IN DEEP LEARNING MODELS

(71) Applicant: GRAND GREAT UG (haftungsbeschränkt), Berlin (DE)

(72) Inventor: Eduard Weinwurm, Vienna (AT)

(21) Appl. No.: 19/302,874

(22) Filed: Aug. 18, 2025

Related U.S. Application Data
(60) Provisional application No. 63/683,773, filed on Aug. 16, 2024.

(51) Int. Cl. G06N 3/084; G06F 16/22

(52) U.S. Cl. CPC G06N 3/084; G06F 16/2264

(57) ABSTRACT

Apparatus and method for reducing the dimensionality of embeddings in a machine learning (ML) system. In some embodiments, original embeddings from a pre-trained deep learning model are extracted for a set of data, the original embeddings having an initial dimensionality. A set of projection vectors are initialized with a specified dimensionality smaller than the initial dimensionality. A neural network is used to optimize the projection vectors by minimizing a loss function based on a similarity matrix. The set of original embeddings are thereafter projected onto the optimized projection vectors to obtain a set of reduced-dimensional embeddings with the specified dimensionality. A neural network of an ML system is thereafter configured using the reduced-dimensional embeddings, such as by a training operation to duplicate operation of the deep learning model in a smaller latent space. The original embeddings may be single modal or multimodal embeddings.

### RELATED APPLICATIONS

The present application makes a claim of domestic priority under 35 U.S.C. 119 (e) to U.S. Provisional Patent Application No. 63/683,773 filed Aug. 16, 2024, the contents of which are hereby incorporated by reference.

### BACKGROUND

Artificial neural networks, also sometimes referred to as machine learning (ML) systems, neural networks (nets), artificial intelligence (AI) systems, etc., are computer-based systems that attempt to mimic the operation of biological neural networks such as found in higher complexity animal brains. Neural networks can be used in a variety of applications including, but not limited to, image and speech recognition, language translation, social media filtering, medical diagnosis, gaming, trend and cyclic forecasting, chatbot systems, graphical generators, musical composition, and so on.

In modern machine learning, particularly in tasks involving multimodal data (e.g., images and text), embeddings are often used to represent high-dimensional data in a lower-dimensional space. Such embeddings can play an important role in vector databases, information retrieval systems, and Retrieval-Augmented Generation (RAG) frameworks.

While useful, embeddings can be computationally expensive to store and process, especially in large-scale applications. There is accordingly a need for reducing the dimensionality of embeddings without significant loss of performance for both storage and computation processing.

### SUMMARY

Various embodiments of the present disclosure are generally directed to reducing the dimensionality of embeddings in a machine learning (ML) system.

In some embodiments, a method includes extracting original embeddings from a pre-trained deep learning model for a set of data, the original embeddings having an initial dimensionality. A set of projection vectors are initialized with a specified dimensionality smaller than the initial dimensionality. A neural network is used to optimize the projection vectors by minimizing a loss function based on an original similarity matrix and a projected similarity matrix. The set of original embeddings are projected onto the optimized projection vectors to obtain a set of reduced-dimensional embeddings with the specified dimensionality. The system uses the reduced-dimensional embeddings to configure a second neural network of a machine learning (ML).

In related embodiments, an apparatus includes a computer system having at least one processor configured to initialize projection vectors of a specified dimensionality in the memory; extract a set of original embeddings from a pre-trained deep learning model realized by the computer processor for a set of data having at least one modality, the set of original embeddings stored in the memory and having an initial dimensionality larger than the specified dimensionality; optimize the projection vectors by minimizing a loss function of a neural network realized by the computer processor in relation to an original similarity matrix and a reduced similarity matrix to generate optimized projection vectors; project the set of original embeddings onto the optimized projection vectors to obtain a set of reduced-dimensional embeddings having an overall informational content that corresponds to an overall informational content of the set of original embeddings; and use the set of reduced-dimensional embeddings to configure a second neural network of a machine learning (ML) system. The second neural network may be configured to duplicate operation of the pre-trained deep-learning model in a reduced latency space.

These and other features and advantages of various embodiments can be understood with a review of the following detailed description in conjunction with a review of the accompanying drawings.

### BRIEF DESCRIPTION OF DRAWINGS

FIG. 1 is a functional block representation of a computer-based system to provide an operational environment in which various embodiments of the present disclosure can be advantageously practiced.

FIG. 2 shows a processing system that can be incorporated into the system of FIG. 1 in accordance with some embodiments.

FIG. 3 is a sequence diagram illustrative of operational steps carried out by the system of FIG. 2 in some embodiments.

FIG. 4 is a functional block representation of a data processing system constructed and operated in accordance with further embodiments of the present disclosure.

FIG. 5 shows an embedding generator system constructed and operated in accordance with further embodiments.

FIG. 6 shows another multimodal processing system constructed and operated in accordance with further embodiments.

FIG. 7 is a flow chart for a dimensionality reduction routine carried out in accordance with further embodiments.

FIG. 8 illustrates operation of the routine of FIG. 7 in a natural language processing environment in further embodiments.

FIG. 9 illustrates operation of the routine of FIG. 7 in a small machine learning (ML) system such as an Edge AI or TinyML environment.

FIG. 10 shows operation of the routine of FIG. 7 in a search engine environment.

### DETAILED DESCRIPTION

Various embodiments of the present disclosure are generally directed to systems and methods for enhancing the accuracy, speed and operational efficiencies of data management systems by reducing the dimensionality of embeddings, such as the type generated by deep learning models such as but not limited to CLIP (Contrastive Language-Image Pretraining) models.

As explained below, the various embodiments disclosed herein are applicable to any number of various types of embeddings for various modalities of data including but not limited to text, image, video, audio, etc. The system is particularly suitable for multimodal embeddings that correlate different modalities of data.

The system allows for the use of larger models that generate higher-dimensional embeddings while still enabling a significant reduction in embedding size. By optimizing projection vectors through a training process that maintains the similarity structure of the original embeddings, this approach compresses the embedding size, leading to substantial savings in processing and storage costs, while also enhancing performance by allowing larger models to operate more efficiently at lower dimensionalities. The various embodiments are particularly relevant in vector databases, information retrieval systems, and Retrieval-Augmented Generation (RAG) frameworks, but other applications are contemplated.

As explained in detail below, a set of projection vectors is optimized through a training process aimed at minimizing the difference between the similarity matrices of the original and reduced embeddings. As desired, the system can leverage selective masking techniques to concentrate the training on the most significant similarities, ensuring that the integrity of the original embedding space is preserved even after dimensionality reduction.

Testing has shown that this approach can reduce embedding size by upwards of 50% or more while maintaining similar performance. Without limitation, the process can be summarized including as follows.

Projection vectors are initialized as a tensor with dimensions (num_meta_vectors, embedding_dim), where num_meta_vectors is a user-defined parameter representing the desired reduced dimensionality, and embedding_dim is the original embedding dimensionality.

An embedding extraction operation next takes place wherein embeddings for both modalities (e.g., images and text) are extracted using a pre-trained model (e.g., CLIP VIT-H/14) and processed to ensure consistent dimensionality. The embeddings serve as input data for the dimensionality reduction process.

The projection vectors are optimized through an iterative process, where a loss function based on the mean squared error (MSE) between the original and projected similarity matrices is minimized. To enhance the optimization process, selective masking techniques may be optionally applied to emphasize critical relationships between embeddings. While some embodiments do not employ masking (e.g., the MSE is sufficient to minimize the error appropriately), it is contemplated that, in at least some cases, the application of masking will tend to facilitate more efficient conversion and dimensionality reduction while preserving the significant similarity relationships among the embeddings. A variety of alternative masking approaches can be used.

In a common approach, substantially any method that applies a mask to reduce the influence of less important similarities within the embedding space can be used, provided that critical relationships are preserved during dimensionality reduction while minimizing data loss in less relevant areas.

Sigmoid masking can additionally or alternatively applied. Sigmoid masking applies a sigmoid function to the normalized similarities, generating a weighted mask that focuses on high-impact similarities and downplays less important ones. Other waveforms can be used (e.g., ReLU, Softmax, Tanh, specially configured waveforms, etc.) as desired to minimize error.

Another masking approach involves top-k masking. This involves retaining only the strongest k similarities in the loss calculation, ensuring that the optimization focuses on the most relevant relationships within the embedding space. For example, the top X number of relationships out of a total number Y may be selected for retention; the top Z % of the relationships may be selected for retention (e.g., top 25%, top 50%, etc.); a selected threshold (e.g., minimum cosine similarity, etc.) may be empirically or heuristically identified and everything equal to or above this threshold may be selected for retention, etc. Other approaches may be used as desired.

Once the masking has been applied (if used), a training process is carried out in which the projection vectors are updated using a gradient descent algorithm, such as Adam, over a defined number of iterations. Monitoring and early stopping approaches may be employed to prevent overfitting, based on evaluation loss.

Once optimized, the projection vectors are used to reduce the dimensionality of the embeddings. The original embeddings are multiplied by the transposed projection vectors to obtain the reduced-dimensional embeddings which are stored and thereafter used. It has been found that the reduced embeddings are typically as if not more significant than the original embeddings, which can lead to significant savings in both processing and storage.

Testing has demonstrated that this method not only substantially maintains the essential features of the original embeddings, but can also enhance overall system performance by enabling the use of larger models. For example, embeddings generated by the VIT-H/14 model, which originally have 1024 dimensions, were reduced by 50% to 512 dimensions. Despite the reduction, these embeddings achieved performance metrics nearly equivalent to the original embeddings and significantly outperformed embeddings generated by models like ViT-L/14 with an original vector size of 768 dimensions.

In another example, an embedding model that began with a dimensional size of 1024 was reduced using the embodiments disclosed herein to produce a final embedding model with a dimensional size of 768 (e.g., 25% reduction in size). This final embedding model performed better than an original model that was initially formed with a dimensional size of 768. In other words, better modeling was achieved by generating a larger model with a first initial size (e.g., 1024) and reducing it to a second target size (e.g., 768) than generating a model of that target size (e.g., 768) from the beginning.

This improved performance may be a result of the foregoing processing emphasizing the more important relationships at the expense of the less important relationships. As a result, the various embodiments can produce superior embedding sets for a given target size. Through iterative processing, the various embodiments can also determine the minimum final dimensionality size that provides the necessary performance levels for a given embedding set.

By reducing the dimensionality of the embeddings, the various embodiments significantly enhance the efficiency of vector databases and information retrieval systems. In RAG frameworks, where embedding processing is important for generating high-quality outputs, this method ensures that larger, more complex models can be used effectively without overwhelming computational resources. Additionally, existing models and their results, as well as databases, can be transformed into much smaller and faster versions, making them more efficient to store, query, and process. The ability to reduce computational overhead while maintaining high performance makes it particularly valuable in applications where both accuracy and efficiency are critical.

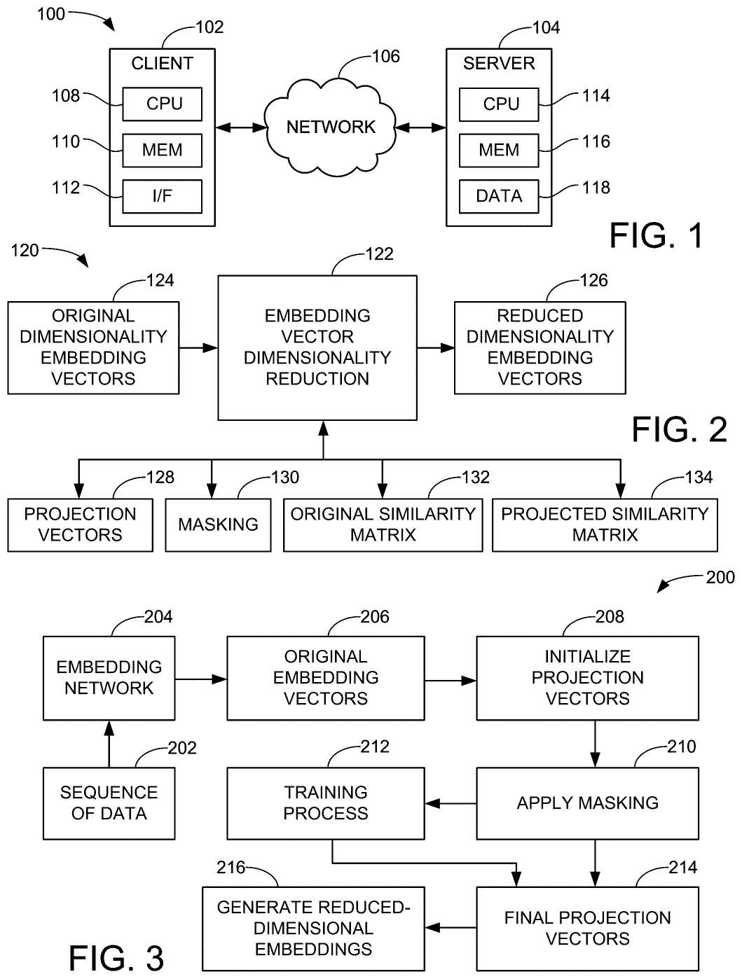

These and other features and advantages of various embodiments can be understood beginning with a review of FIG. 1 which shows an exemplary data processing system 100. The system 100 includes a local client (host) device 102 and a remote server 104 coupled to the client device 102 via an intervening computer network 106. Other arrangements can be used, so it will be understood that the configuration of FIG. 1 is merely illustrative and is not limiting.

The client device 102 (also sometimes referred to as a user device or an agent device) may take any number of forms such as a desktop computer, a laptop, a tablet, a smart phone, a workstation, a gaming console, a LAN, a terminal, or some other form of interactive device suitable for use by an agent in accessing the system. As used herein, the term “agent” will be understood as referring to a human or artificial (non-human) user of the system. Artificial users of the system can include AI-based systems, robots, programs, routines, or other entities that utilize the system. It will be appreciated that, as explained below, the various embodiments described herein can be incorporated into any number of different processing environments and sequences. Reference to the “user” will thus be understood as covering either or both a human or non-human agent.

The client device 102 includes a client controller (CPU) 108, memory 110 and an agent interface (I/F) 112. The controller 108 may be a programmable processor that executes software/firmware stored in the memory 110, including one or more applications (apps) or other routines. One or more hardware processors or other logic can be used in conjunction with, or in lieu of, the programmable controller 108. The agent interface 112 may include a display, pointing device, touch screen, keyboard, and/or any other elements useful in providing an agent interface for the particular agent or agents that use the system.

The server 104 is shown to similarly incorporate a server (network) controller (CPU) 114, memory 116 and data 118. The server 104 may be a gateway that in turn connects to other nodes in the network to provide the required functionality. In some cases, the operation of the system is carried out by the execution of one or more routines that are stored and executed locally at the client level, remotely at the server level, or both. The data represents a data repository or library that stores the evaluated data sets (files, objects, clips, etc.) and such storage may be local, remote, or both.

The network 106 may be a local network, a public network, a private network, a cloud or edge computing distributed network, the Internet, or some other suitable arrangement. Data centers, container storage, local and web-based applications and other techniques can be utilized as required without limitation. GPU based workstations or other localized systems are also contemplated.

FIG. 2 shows a data processing system 120 that can be incorporated into the system 100 of FIG. 1 in some embodiments. The system 120 includes an embedding vector dimensionality reduction module 122, which can be realized in hardware, software, firmware, or any combination thereof. The module 122 operates upon an input set of original dimensionality embedding vectors 124 to generate a corresponding set of reduced dimensionality embedding vectors 126. To this end, the module 122 generates and uses a number of data objects and operational modules including a set of projection vectors 128, a mask 130, an original similarity matrix 132 and a projected similarity matrix 134.

The original embedding vectors 124 may be generated by an ANN (such as a deep learning model) or some other source and will have a first dimensionality, such as 1024 dimensions or some other value. The dimensionality will provide a description of each element of a training set in a multi-dimensional latent space. As described herein, the module 122 reduces the overall dimensionality of the output embedding vectors 126, such as to 512 dimensions, 768 dimensions, etc. while retaining the most significant similarity measures for the input data set. It will be appreciated that the output embedding vectors 126 are thereafter stored and utilized in lieu of the original embedding vectors, and operations thereon provide similar, the same, or even improved performance over the original set.

FIG. 3 provides a sequence flow diagram 200 to illustrate operation of the system 120 of FIG. 2 in some embodiments. Other arrangements can be used. A sequence of data is initially supplied at block 202 to an embedding network, such as but not limited to a CLIP ANN deep learning model. In situations where multiple channels of data are used (e.g., audio and video, etc.), separate sets of embedding vectors 206 are generated for each type with an initial dimensionality. In the present case, 1024 dimensions are used although any arbitrary number can be assigned for the initial vector generation process. Each embedding vector provides a vector representation (tensor) of that element, and relative similarities among elements can be expressed in relation to a similarity measure (e.g., cosine similarity, etc.) among the respective vectors.

A set of projection vectors 208 are next initialized. These are iteratively adjusted as discussed below, but initially are set for a reduced size. In some cases, multiple sets of projection vectors are generated and iteratively evaluated to select the final set of output embeddings. In one example, a first set of projection vectors are set at a dimensionality that is 50% of the initial setting, such as 512 dimensions.

Masking is next applied as desired at block 210. As noted above, a variety of masking approaches may be used, including multiple approaches. One suitable approach is the previously mentioned top-k masking where a selected percentage of the most similar pairings above a selected threshold are selected. In this way, the less-important associations are lost while these more-important associations are retained.

An iterative training process is next carried out at block 212 using a neural network such as a transfer learning network, where a loss function is calculated and reduced through adjustments to the projection vectors of block 208. In some cases, a mean square error (MSE) approach is used. The low similarity associations are masked out and hence, do not contribute to the loss function processing.

After suitable training of the network, a final projection vector is generated, block 214, and this is combined with the original embedding vectors (block 206) to output the final reduced dimensional embeddings. Further evaluation and testing can be carried out to verify the results, and to determine if further reductions can be made (in which case the flow returns to block 208 with a new set of projection vectors.

Once the final embeddings are generated (block 216), such are stored and used in substantially any way that the original embedding vectors (block 206) could be used. This includes but is not limited to searching, content generation, classification, or other functions as required.

The performance of the reduced-dimensional embeddings is evaluated by comparing their effectiveness in retrieval tasks against the original embeddings. Metrics such as Recall@1 (R@1), Recall@5 (R@5), and median rank may be used to assess the quality of the reduced embeddings.

In practical scenarios, this method enables the deployment of larger, more powerful models in environments where computational resources are limited, achieving a balance between performance and efficiency. This is especially useful in vector databases and RAG systems, where rapid, accurate retrieval can be essential.

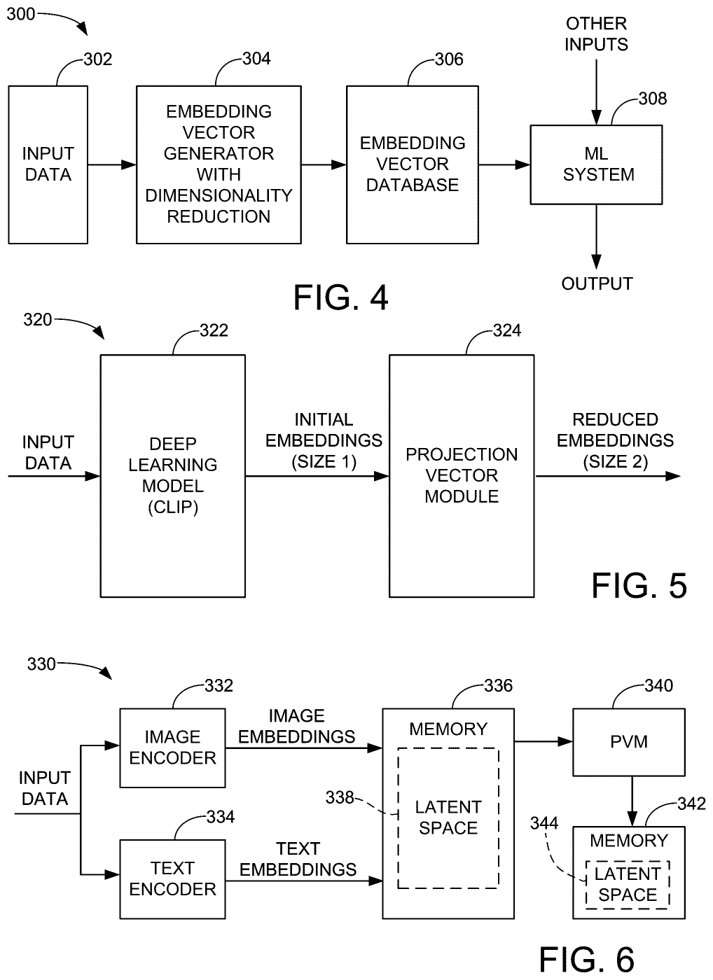

FIG. 4 shows another data processing system 300 constructed and operated in accordance with further embodiments of the present disclosure. While these details are not separately depicted in detail, it will be understood the system is computer based and may utilize one or more programmable or hardware processors and suitable programming instructions in the form of firmware, software, apps, etc. to execute the various functions described herein.

While not limiting, in some cases the system 300 represents a large scale, geographically distributed data processing system that involves servers that communicate over a network, including the Internet, to store, transfer and process large data sets. Cloud computing, container, edge computing and other processing techniques and data storage and management systems, including mass data storage arrays involving data storage devices, can be utilized as required. Local client devices can be provided to enable user access and operation. Local workstation level processing can alternatively be utilized.

Input data are generally represented at 302 and are stored in one or more data storage devices with associated non-volatile memory. The data can take any number of types, including but not limited to a local or remote repository of digital content, such as a server or drive that stores user data sets (e.g., files, objects, etc.). While not limiting, the data sets may constitute media elements of various types including, but not limited to, videos, movies, sound recordings, podcasts, text articles, documents, images, etc. as described above. Other forms of data can be processed as well.

An embedding vector generator 304, also referred to as a model, transforms the various input data elements into a corresponding set of embedding vectors with reduced dimensionality as described herein. The generator 304 may be a single module or multiple modules that operate to generate a final set of embedding vectors with reduced dimensionality.

As described previously, each embedding vector is a string of numbers in an n-dimensional space that represents various features, characteristics, measures, etc. of the associated input data element. Control data can be incorporated into the embedding vector. The transformation can take any number of forms, but generally results in the generation of one or more multi-dimensional vectors in a latent space defined by the model. The particular form of a given embedding vector will of course depend on the model, and any number of different types of embedding vector formats can be used as required. Different forms and types of embedding vectors may also be provided for different types of input data.

In the case of a movie, each frame of the video may be identified and processed using a neural network function of the model to generate a corresponding multi-dimensional vector. Compression, similarity measures and groupings of vectors can be made as desired, depending on the model and system requirements.

Text and similar types of data that do not have a repetitive, equally time-spaced sequence like a frame rate may result in the dividing of the content into appropriate groupings, such as sentences, which can vary greatly in length and are often arbitrary. Context processors can evaluate the content of these groupings to assign values within the vector space for each unit. A moving or sliding window of different length on the sequences (part of sentence, full sentence, group of sentences, etc.) may be used to obtain combined vectors.

Audio recordings, such as but not limited to dialog or monologue data in a podcast or other types of data may use speech-to-text conversion, context evaluation and other techniques to identify segments of associated content. The segments can be identified and combined vectors generated as before for each segment. Images can be processed using spectral content, object detection, velocity and other parameters to map the images to the vector space. Other forms of input data elements can be similarly encoded.

The resulting embedding vectors can be stored in a suitable memory as a database 306, which can then be used, as desired, as an input to a machine learning (ML) system 308 for various purposes. While not limiting the ML system 308 can be a search engine, a rendering system, a neural network model that uses the input data along with other inputs to generate a desired output, and so on.

The reduced dimensionality of the embedding vectors in the database 306 advantageously enables the processing capabilities and efficiencies of the ML system 308, including reducing the amount and extent of resources (including RAM and IOPS) needed to access and use the embeddings, as well as significant reductions in power consumption and generated heat during operation of the system.

FIG. 5 shows an embedding generator system 320 in accordance with further embodiments. In some cases, the system 320 can correspond to the block 304 in FIG. 4, or other configurations can be used. The system 320 includes a CLIP based deep learning model 322 that generates an initial, first set of embeddings with a first size (dimensionality), followed by a back end projection vector module 324 that operates as an output layer to perform projections as described herein to output a reduced, second set of embeddings with a second reduced size (dimensionality).

The back end module 324 can be further fine tuned through the application of additional training to further enhance system performance, or the projection layer can be frozen (e.g., no further training) as a transformation model that operates upon the output from the CLIP stage.

FIG. 6 shows another processing system 330 in accordance with further embodiments. The system applies multimodal processing (such as CLIP based) to input data via an image encoder 332 and a text encoder 334 to provide embeddings in different modalities into a shared latent vector space 338 in physical memory 336. While not limiting, the image encoder 332 may use a convolutional neural network (CNN) and the text encoder may use transformer-based encoding, but other techniques can be used as desired.

As will be appreciated, the term modality refers to the type of data (e.g., image, text, audio, video, etc.), embeddings are numerical representations (vectors) of those data, and the multimodal embeddings combine these into a single space so that semantically similar items (e.g., a photo of a dog and the word “dog”) are close together within the space 338. While CLIP (Contrastive Language-Image Pretraining) processing has been described as a particularly suitable technique, substantially any types of modalities and processing techniques can be used, including but not limited to the use of joint embedding models, cross-modal transformers, multimodal autoencoders and graph neural networks. Moreover, while two modalities are contemplated, more than two can be readily incorporated into the system as desired (e.g., text, video and audio, etc.), and single modality analyses (e.g., just text, etc.) can be used.

Continuing with the system 330 in FIG. 6, a projection vector module (PVM) 340, similar to the modules described previously (see e.g., 324, FIG. 5), operates upon the multimodal embeddings to provide a set of reduced embeddings in a smaller latent space 344 in a smaller memory space 342. It will be appreciated from FIG. 6 that significant processing, memory and resource efficiencies can be gained from the transformation of the information into the smaller embedding set within memory 342, particularly since the informational content of the larger latent space 338 with higher dimensions is substantially, or fully, preserved within the smaller latent space 344 with lower dimensions.

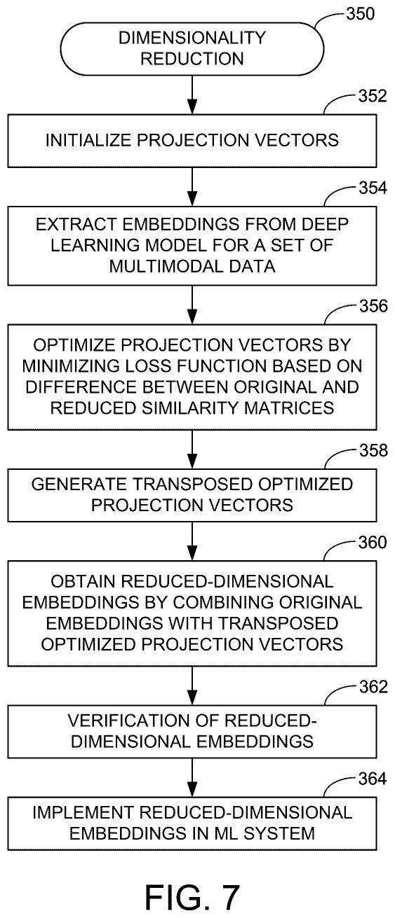

FIG. 7 provides a flow chart for a dimensionality reduction routine 350 carried out in accordance with various embodiments. It will be appreciated that the routine is merely illustrative and steps may be modified, omitted, appended, performed in a different order, etc. as required. While the routine is particularly suited to multimodal embeddings, such is not necessarily required as single modal embeddings may be processed as well. In general, FIG. 7 carries out the following methodology.

Given a dataset consisting of items

$${\{ {X}_{i} \}}_{i = 1}^{T}$$

and a function ƒ that generates embeddings eᵢ=ƒ(Xᵢ), where eᵢ ∈ R^{d}, the goal is to project these embeddings into a lower-dimensional space R^{k} using a set of meta-vectors V ∈ R^{k×d}.

The projection of the embeddings e; onto the meta-vectors V can be defined as follows:

$${p}_{i} = {Ve}_{i}^{T} \qquad ( 1 )$$

where pᵢ ∈ R^{k} represents the reduced-dimensional embedding of Xi.

The use of a similarity matrix serves to capture the pairwise relationships between all items in the dataset. Whether the task is single-modal (embeddings from the same modality) or cross-modal (embeddings from different modalities, such as images and texts), the process of constructing the similarity matrix follows these general steps.

First, initial embeddings are computed for all items in the data set. In single-modal tasks, these embeddings e; are from the same modality (e.g., all text, etc.). In cross-modal (multimodal) tasks, embeddings are obtained from different modalities, such as image embeddings e^{image i} and text embeddings e^{text j}.

Next, a pairwise similarity calculation is performed. For each pair of items i and j, a cosine similarity is calculated between their corresponding embeddings. A suitable formula for cosine similarity is as follows:

$$sim ( {e}_{i} , {e}_{j} ) = \frac{{e}_{i} \cdot {e}_{j}}{‖ {e}_{i} ‖ ‖ {e}_{j} ‖} \qquad ( 2 )$$

In single-modal tasks, this similarity is calculated between all pairs of items within the same modality. In cross-modal tasks, the similarity is calculated between pairs of items from different modalities, such as between an image embedding and a text embedding.

A similarity matrix S is next constructed. For single-modal tasks, S is a square matrix where S[i,j] represents the similarity between item i and item j within the same modality. The matrix is symmetric, with diagonal elements equal to 1. For cross-modal tasks, S is a rectangular matrix where S[i,j] represents the similarity between item i from one modality and item j from the other modality. This matrix is not symmetric, as it compares items from different modalities.

There are two versions of similarity matrices formed: an original similarity matrix S_{orig} and a projected similarity matrix Sₚᵣₒⱼ. The original similarity matrix S_{orig} is constructed using the original high-dimensional embeddings eᵢ, and serve as a reference for how items are related in the original feature space. The projected similarity matrix Sₚᵣₒⱼ. is constructed using the lower-dimensional embeddings obtained after projection. The optimization process aims to make Sₚᵣₒⱼ closely match S_{orig}, preserving the relationships encoded in the original embeddings.

The similarity matrices Sₚᵣₒⱼ and S_{orig} are used in subsequent steps, including the application of masking strategies and the computation of the loss function during optimization. By comparing Sₚᵣₒⱼ with S_{orig}, the system can assess how well the lower-dimensional embeddings maintain the structure of the original data.

While optional, a masking strategy may next be employed. The masking strategy is generated based on the original similarity matrix S_{orig}. These masks are applied during the loss calculation to both similarity matrices Sₚᵣₒⱼ and S_{orig}.

The purpose of the mask is to selectively emphasize or de-emphasize specific similarity pairs when calculating the loss. By doing so, the optimization process is guided to focus on preserving or enhancing the most important relationships as determined by the original similarity matrix. As noted previously, any number of masking strategies can be used.

In top-k masking, the following process may be used. For each embedding ei, retain the top-k most similar embeddings ej, creating a binary mask mᵢⱼ where mᵢⱼ=1 if j is within the top-k similar embeddings for i.

In weighted masking, the following process may be used. Apply a continuous mask based on a sigmoid function to the original similarities:

$${m}_{ij} = σ ( α ( sim ( {e}_{i} , {e}_{j} ) - τ ) ) \qquad ( 3 )$$

where α controls the steepness of the sigmoid and τ is a threshold parameter.

Once these values have been determined, the meta-vectors are optimized to develop the final set of reduced-dimensional embeddings. The goal during this operation is to minimize the difference between the masked projected similarity matrix Sₚᵣₒⱼ and the masked original similarity matrix S_{orig}, where:

$$Sorig [ i , j ] = sim ( ei , ej ) \qquad ( 4 )$$

A loss function L is defined as follows:

$$L = {\sum }_{i = 1}^{N} {\sum }_{j = 1}^{N} {m}_{ij} ( {S}_{proj} [ i , j ] - {( {S}_{orig} [ i , j ] )}^{2} \qquad ( 5 )$$

Mean Squared Error (MSE) is particularly effective in this context because it naturally emphasizes higher similarity values due to the squaring of errors. This property of MSE complements the masking strategies, which are designed to selectively emphasize or de-emphasize specific similarity pairs based on their importance in S_{orig}. The meta-vectors V may be optimized using gradient-based methods, such as Adam, to minimize this loss. Early stopping of the training may be employed to prevent overfitting, based on the evaluation performance on a held-out validation set.

Turning now to the routine 350, step 352 provides an initialization operation in which an initial set of projection vectors are initialized. As discussed above, this initialization can take place in a number of ways, including initialization of the projection vectors as a tensor with dimensions (num_meta_vectors, embedding_dim), where num_meta_vectors is a user-defined parameter representing the desired reduced dimensionality, and embedding_dim is the original embedding dimensionality.

By way of illustration, embedding_dim may be the dimensionality of the initial latent space 338 (such as, e.g., 1024 dimensions or some other value), and num_meta_vectors may be the dimensionality of the final latent space 344 (such as, e.g., 512 dimensions or some other value). Normally, it is contemplated that the resulting vectors will have a smaller dimensionality than the original vectors, but there may be situations where it is beneficial to perform a same-size transformation or even an enlargement transformation, so that the final vectors are the same-size or even larger dimensionally than the original vectors.

Once initialized, the process continues at step 354 where an embedding extraction operation takes place. Here, embeddings for both modalities (e.g., images and text) are extracted using a pre-trained model (e.g., CLIP VIT-H/14) and processed to ensure consistent dimensionality. The embeddings serve as input data for the dimensionality reduction process. This can include the operation of the respective encoders 334, 336 in FIG. 6.

An optimization of the projection vectors takes place at step 356. As described previously, this may involve the training of a neural network that is optimized through an iterative process so that a loss function L, such as based on MSE between the original and projected similarity matrices Sₚᵣₒⱼ and S_{orig}, is minimized. As desired, selective masking techniques can be used to enhance the optimization process.

Once the projection vectors have been optimized, the optimized projection vectors are used to reduce the dimensionality of the original embeddings. This can be carried out by generating a transpose of the optimized projection vectors, step 358, followed by combining the original embeddings with the transposed optimized projection vectors such as through multiplication, step 360 (see equation (1)).

It may be desirable to verify the reduced dimensional embeddings prior to use, as shown at step 362. This can be carried out in a number of ways, including matching search results or other accesses of the respective embedding sets, statistical analyses upon the respective embedding sets, obtaining performance metrics from both sets, and so on. Gains can also be evaluated to determine if the reduction is sufficient to meet system performance needs, and further reductions or other adjustments to the final embedding set can be performed.

Thereafter, the reduced-dimensional embeddings are used in an ML system application. This can include replacement of the original embeddings with the new embeddings, use of the reduced set embeddings for initial accesses prior to subsequent accesses to the original embeddings, or distribution of the reduced set embeddings to a secondary system to enable remote access and performance while maintaining operability of the original system. Nonlimiting examples of the deployment of the reduced-dimensionality embeddings include the following.

### Example 1—Natural Language Processing (NLP) Optimization

The disclosed method enables compression of high-dimensional word embedding vectors into a reduced-dimensional representation while preserving semantic relationships. This transformation reduces memory footprint and accelerates inference time in natural language processing systems, thereby improving the responsiveness and scalability of conversational agents and text classification models.

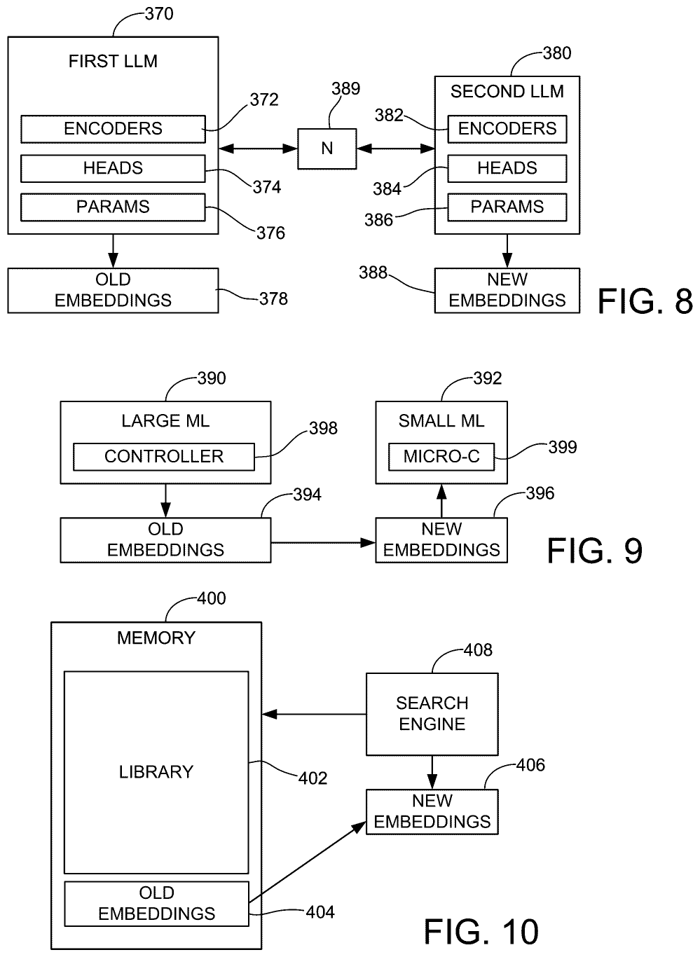

In this case, the reduced and original sets of embeddings will both be text-based, not necessarily multi-modal. FIG. 8 shows a first LLM (large language model) system 370 that includes transformers 372, attention heads 374 and parameters 376, among other elements as known in the art. Using the techniques described herein, a set of old (large) embeddings at a first dimensionality (such as 1024) can be generated to describe this first system 370. A second LLM 380 can be generated and deployed based on a new (reduced) embedding set 389 with corresponding transformers 382, attention heads 384 and parameters 386, among other elements. The second LLM 380 may be resident on a local computer of a user.

The second LLM 380 can replace the first LLM 370, or can be separately deployed in a local environment to provide remote operation comparable to that provided by the first LLM 370. Because of the significant reductions in processing requirements, energy usage, memory requirements, and potentially faster inference speed based on the reduced size of the model, the second LLM 380 may be deployed locally for the user, eliminating cloud based transfers across a network 389 as are currently required by existing LLMs and other large inference systems.

### Example 2—Edge AI Deployment

A related application is the implementation of local machine learning systems, such as Edge AI or TinyML systems, where significantly smaller controllers and memory resources are available, including but not limited to a sensor-based micro-controller (micro-c) application.

In this case, an overall ML system can be trained having a first larger dimensionality, and through the dimensionality reduction a smaller footprint system can be derived for local use, such as illustrated by large ML system 390 and small ML system 392 in FIG. 9. As before, old embeddings for the large system are shown at 394, and new embeddings for the small system are shown at 396.

In this way, a larger and more complete model can be initially generated using a more powerful processor and memory environment, such as involving a server or GPU, as indicated by controller 398. This larger model can be reduced in size for duplicated operation in a smaller latent space such as via micro-controller 399 in the small ML system 392. It will be noted that the informational content of the larger ML system 390 (via old embeddings 394) are transferred and used in the small ML system 392 (via new embeddings 396). The new embeddings 396 may be used, for example, to configure (e.g., train) another neural network realized by the micro-controller 399 to operate in such a way as to duplicate the operation of a neural network of the larger ML system, but in a reduced latency (and memory) space.

This provides a number of advantages including reduced memory space, energy usage, network communications and faster response times. In some cases, follow-on training and updates to the small ML system 392 in the operative environment can be carried out. In this way, the larger system can spawn multiple smaller copies, each of which are individually tuned for each separate application environment.

### Example 3—Library Search Engine

The system compresses document embedding vectors used in semantic search and information retrieval systems. By reducing dimensionality while preserving contextual relevance, the method improves indexing efficiency, reduces storage requirements, and accelerates query response times in large-scale search engines. Another application of this technique is the generation of a search engine to allow searching for desired content.

As shown in FIG. 10, a library of works 402 is stored in memory 400, such as but not limited to audiovisual (AV) works. A large embedding set 404 at a first dimensionality is generated as discussed herein from the library 402. The large embedding set 404 can be used to generate a reduced size embedding set 406 at a smaller second dimensionality but which substantially retains the informational content of the large embedding set 404. Once the reduced size set 406 is generated, the large set 404 can be retained or deleted. A search engine module 408 accesses the reduced size set 406 responsive to user queries to perform searches of the content of the library 402s.

In some cases, searches can be carried out on the vectors 406 directly, allowing accesses to the library as required for retrieval and display for the user. In other cases, faster preliminary searches can be performed using the vectors 406, and the top X search results can be used to provide a more detailed search using the vectors 408. In both cases, the smaller vectors 406 provide faster and more efficient access operations, enhancing system performance, energy consumption, network access rates and response time for the user.

The foregoing are merely examples of practical applications of the reduced size embedding vector sets. Other applications include, without limitation, medical imaging analysis, real-time cyber security threat assessment systems, autonomous vehicle sensor functions, and so on. These and other ML based applications can improve responsiveness and accuracy of the ML system employing the reduced embedding set by significantly reducing computational overhead while maintaining high performance otherwise achievable by the larger embedding set.

The system particularly enhances the efficiency of vector databases and information retrieval systems. In RAG frameworks, where embedding processing is critical for generating high-quality outputs, the system ensures that larger, more complex models can be used effectively without overwhelming computational resources. Additionally, existing models and their results, as well as databases, can be transformed into much smaller and faster versions, making them capable of more efficiently store, query, and process data.

What is claimed is:

1. A method, comprising:
in a computer processor having program instructions stored in a memory,
configuring the computer processor to carry out the following operations:
initializing projection vectors of a specified dimensionality in the memory;
extracting a set of original embeddings from a pre-trained deep learning model realized by the computer processor for a set of data having at least one modality, the set of original embeddings stored in the memory and having an initial dimensionality larger than the specified dimensionality;
optimizing the projection vectors by minimizing a loss function of a neural network realized by the computer processor in relation to an original similarity matrix and a reduced similarity matrix to generate optimized projection vectors; and
projecting the set of original embeddings onto the optimized projection vectors to obtain a set of reduced-dimensional embeddings having an overall informational content that corresponds to an overall informational content of the set of original embeddings; and
using the reduced-dimensional embeddings to configure a second neural network of a machine learning (ML).

2. The method of claim 1, further comprising evaluating performance of the reduced-dimensional embeddings in the ML system using retrieval metrics associated with the set of data.

3. The method of claim 1, further comprising applying a mask to each of the original similarity matrix and the reduced similarity matrix during the optimizing of the projection vectors.

4. The method of claim 1, wherein the second neural network of the ML system is trained on the reduced-dimensional embeddings.

5. The method of claim 4, wherein the trained second neural network duplicates operation of the pre-trained deep-learning model in a reduced latency space.

6. The method of claim 1, wherein the projection vectors are optimized using a gradient descent algorithm with early stopping based on evaluation loss.

7. The method of claim 1, wherein the accessing step comprises using the reduced-dimensional embeddings in a retrieval task to identify and retrieve data responsive to a search query.

8. The method of claim 1, wherein the specified dimensionality is at least 25% smaller than the initial dimensionality.

9. The method of claim 1, wherein the specified dimensionality is at least 50% smaller than the initial dimensionality.

10. The method of claim 1, wherein the initial dimensionality is 1024 dimensions and the specified dimensionality is 768 dimensions or less.

11. The method of claim 1, wherein the computer processor is a server processor or a GPU processor, and the using step comprises transferring the reduced-dimensional embeddings across a network to a memory accessible by a micro-controller of the ML system at a location remote from the computer processor.

12. The method of claim 1, wherein the original similarity matrix is constructed using the set of original embeddings, the projected similarity matrix is constructed using the set of reduced-dimensional embeddings, and the optimizing step conforms the projected similarity matrix to the original similarity matrix while preserving relationships encoded in the set of original embeddings.

13. An apparatus, comprising:
a computer system comprising at least one computer processor having program instructions stored in a memory, the at least one computer processor configured to::
initialize projection vectors of a specified dimensionality in the memory;
extract a set of original embeddings from a pre-trained deep learning model realized by the computer processor for a set of data having at least one modality, the set of original embeddings stored in the memory and having an initial dimensionality larger than the specified dimensionality;
optimize the projection vectors by minimizing a loss function of a neural network realized by the computer processor in relation to an original similarity matrix and a reduced similarity matrix to generate optimized projection vectors;
project the set of original embeddings onto the optimized projection vectors to obtain a set of reduced-dimensional embeddings having an overall informational content that corresponds to an overall informational content of the set of original embeddings; and
configure a neural network of a machine learning (ML) system with the set of reduced-dimensional embeddings.

14. The apparatus of claim 13, wherein the at least one processor is further configured to evaluate performance of the reduced-dimensional embeddings using retrieval metrics.

15. The apparatus of claim 13, wherein the at least one processor further operates to apply masking to the original similarity matrix and the projected similarity matrix during the optimization of the projection vectors.

16. The apparatus of claim 13, wherein the projection vectors are optimized using a gradient descent algorithm with early stopping based on evaluation loss.

17. The apparatus of claim 13, wherein the ML system uses the reduced-dimensional embeddings in a retrieval task to identify and retrieve data responsive to a search query.

18. The apparatus of claim 13, wherein the computer processor is a server processor or a GPU processor, and the accessing step comprises installing the reduced-dimensional embeddings in a micro-controller of the ML system at a location remote from the computer processor.

19. The apparatus of claim 13, wherein the original similarity matrix is constructed using the set of original embeddings, the projected similarity matrix is constructed using the set of reduced-dimensional embeddings, and computer processor conforms the projected similarity matrix to the original similarity matrix while preserving relationships encoded in the set of original embeddings.

20. The apparatus of claim 13, wherein the second neural network of the ML system is trained on the reduced-dimensional embeddings to duplicate operation of the pre-trained deep-learning model in a reduced latency space.

21. The apparatus of claim 13, wherein the specified dimensionality is at least 25% smaller than the initial dimensionality.

22. The apparatus of claim 13, wherein the specified dimensionality is at least 50% smaller than the initial dimensionality.
